(19) United States
(12) Patent Application Publication
(10) Pub. No.: US 2007/0051763 A1
(43) Pub. Date: Mar. 8, 2007

(54) Adjustable golf bag holder

(76) Inventor: George Adrian, Spring Valley, IL (US)

Correspondence Address: Michael Romani, 2579 W. Los Flores Ct,, Meridian, ID, 83646, US

(21) Appl. No.: 11/219,380

(22) Filed: Sep. 3, 2005

(51) Int. Cl. B60R 9/00; B60R 11/00

(52) U.S. Cl. 224/274; 224/553; 224/568

(57) ABSTRACT

An adjustable removable golf bag holder intended for use on a variety of available golf carts is described. The holder can be installed with or without modification to the golf cart. The adjustable removable holder described is secured to the golf cart in such a way to allow a golf bag to be attached and secured into the holder and positioned by a golfer at a height or angle preferred by the golfer to facilitate easier club retrieval and selection while keeping the bag secure while the cart is in motion. Once the golf cart is modified, the attachable holder is also easily attached and removed for easy transfer and storage.

### FIELD OF THE INVENTION

The present invention relates to golf bag holders in general and specifically to mountable and adjustable golf bag holder attachments to golf carts.

### BACKGROUND OF THE INVENTION

As the sport of golf gains in popularity, golf courses are becoming increasingly busy making it more difficult for golfers to schedule play at the time of their choosing. To allow this increasing number of golfers to play at convenient times, and consequently allowing larger numbers golfers to play on any given day, more and more golf courses are requiring golfers to ride in motorized golf carts to speed play. As a convenience to the golfer, a golf bag holder is typically included as a standard feature on most golf carts. Golf bag holders come in numerous designs and capabilities. The most common of these being integrated into the rear of the golf cart allowing the golfer to place his or her golf bag in the upright position and securing the bag to the cart.

Although the common integrated golf bag holder provides a convenience to the golfer, its positioning makes it difficult for several categories of golfers to retrieve and select golf clubs. Because of its location on the golf cart, the top of a typical golf bag placed in a golf cart may be four or more feet above ground level. In addition to the height of the top of the golf bag above ground level, the golfer must then remove a club, lifting it high enough to clear the top of the golf bag, increasing this height by several feet, making club removal difficult. For example, young golfers or shorter adult golfers may not be tall enough to easily reach or see the engraved club identifier while the club is still in the bag, making club selection more time consuming and club removal difficult. Older golfers with limited flexibility also may have difficulty reaching the top of the golf bag and removing their clubs.

Adding any type of device to the rear of a golf cart raises several concerns regarding the space each cart will take to store and/or transport. Additionally, devices that must be removed for storage or transport and then reinstalled for play decrease the usefulness of such devices and increase the likelihood of injury during the removal or installation process. When golf carts are stored at a golf course or transported by trailer in bulk between golf courses, the carts are closely grouped together for efficiency. Other known devices are either permanently attached to the golf cart or are bulky and cumbersome, and therefore difficult to install and remove diminishing their usefulness.

There is a need for a golf bag holder that addresses some or all of these problems.

### SUMMARY OF THE INVENTION

The described invention relates to attachments to golf carts, and specifically to an adjustable removable golf bag holder which allows for greater ease of use by several categories of golfers.

The present invention addresses several deficiencies in golf bag holders. One embodiment of the invention provides a golf bag holder that is adaptable to many of the various makes and models of golf carts utilized at private and public golf courses. As such, some embodiments of the invention requires no or minor modification to a golf cart, allowing for short and easy initial installation, minimizing the initial installation time required.

Embodiments of the present invention allow mounting of the invention to a golf cart through structural elements already present on most golf carts thereby requiring no modification or alteration to the golf cart to allow installation of the described holder. Other embodiments allow for installation of the described holder onto golf carts without the already present structural elements through alteration of the golf cart structure.

Embodiments of the invention assist several categories of golfers play by allowing for improved club selection and decreasing the physical requirements and time for removal and replacement of golf clubs from a golf bag during play.

Embodiments of the invention provide adjustability allowing for individualized position and height of the golf bag. This adjustability can be accomplished through set stop points, allowing for a limited positioning of the holder angle available to the golfer. Other embodiments allow for this adjustability to provide for continuous positioning throughout the effective range of the holder through the use of pneumatic or hydraulic friction or through the positioning of an adjustable securing device, such as a thumb screw. This continuous mechanism allows for a more user customizable positioning of the attached golf bag. Additionally, this adjustability allows for the storage and transport of the modified golf carts without the need to uninstall the described holder. The adjustability also decreases the likelihood of injury by not requiring removal and reinstallation of the described holder as is required with other known devices. The adjustable feature farther allows for easy placement and removal of individual golf bags.

These and other features of the invention will be more apparent from the following detailed description that is provided in connection with the accompanying drawings and illustrated embodiments of the invention.

### BRIEF DESCRIPTION OF THE DRAWINGS

FIG. 1 illustrates a golf bag holder of one embodiment of the present invention positioned within a golf cart.

FIG. 2 illustrates an embodiment of a golf bag holder of FIG. 1.

FIG. 3 illustrates an embodiment of a golf bag securing mechanism.

FIG. 4 illustrates an embodiment of a mounting structure.

FIG. 5 illustrates structural elements of a common golf cart.

FIG. 6 illustrates an embodiment of the adjustable support.

FIG. 7 illustrates a cross sectional view of the adjustable support.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized, and that structural and logical changes may be made without departing from the spirit and scope of the present invention

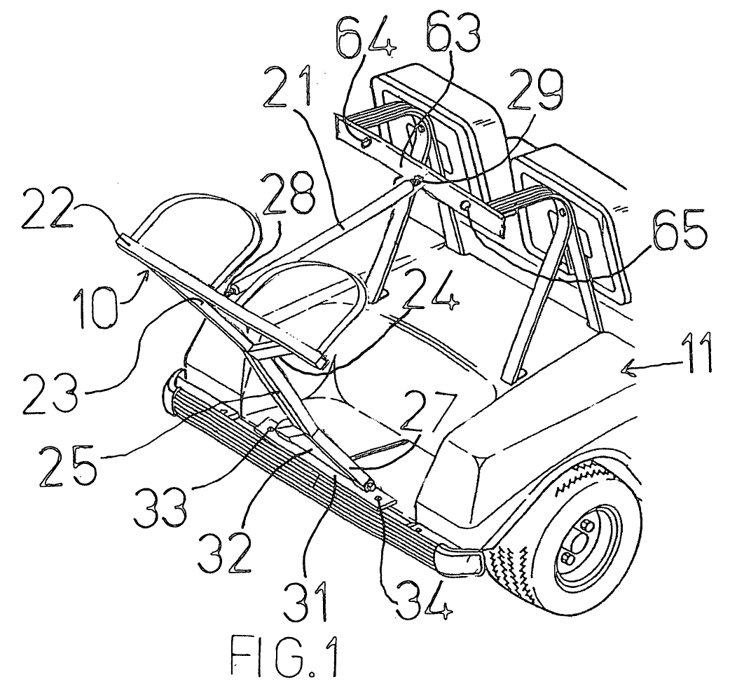

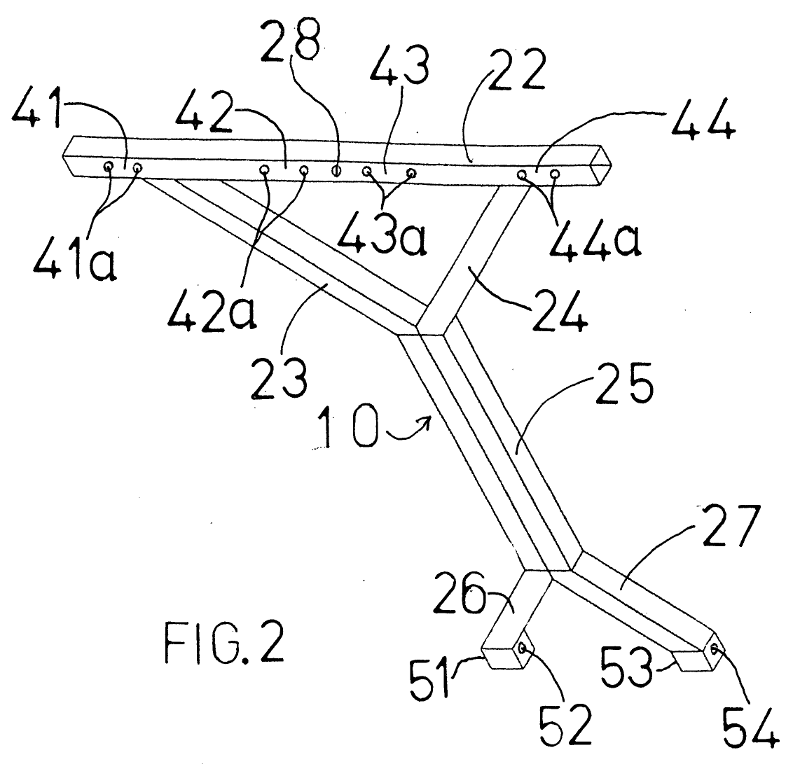

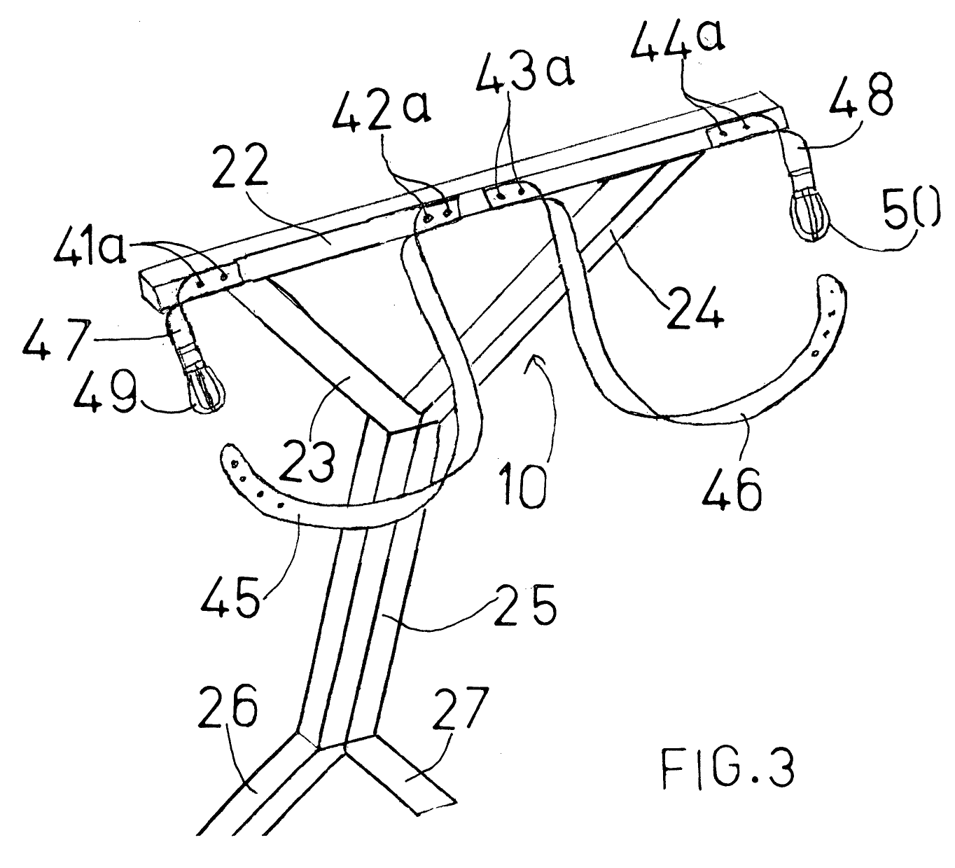

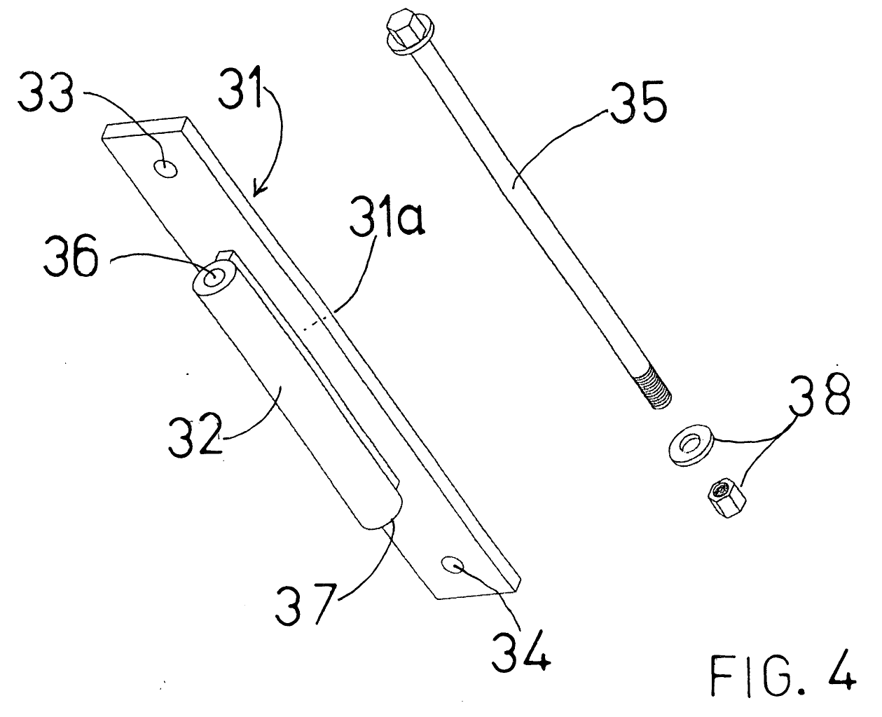

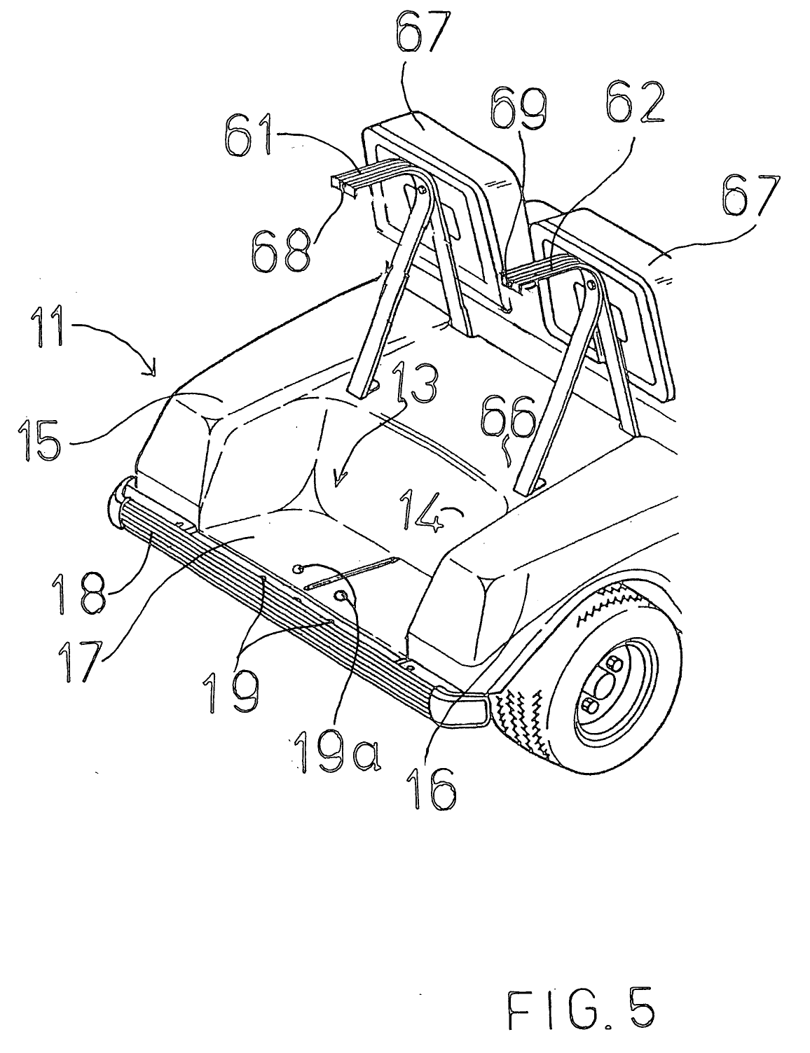

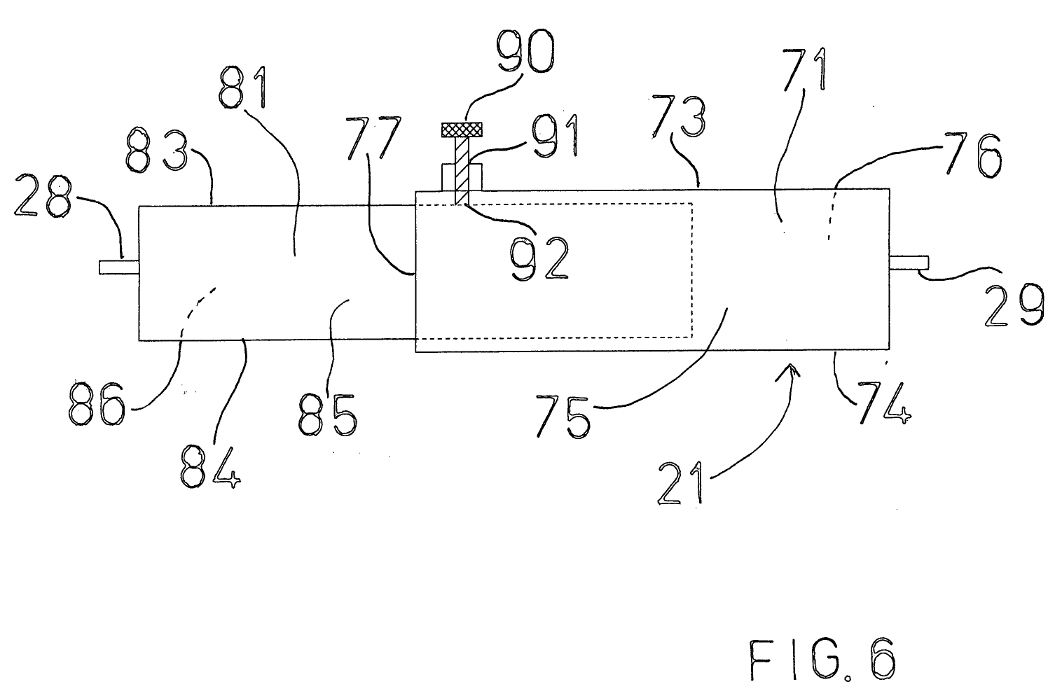

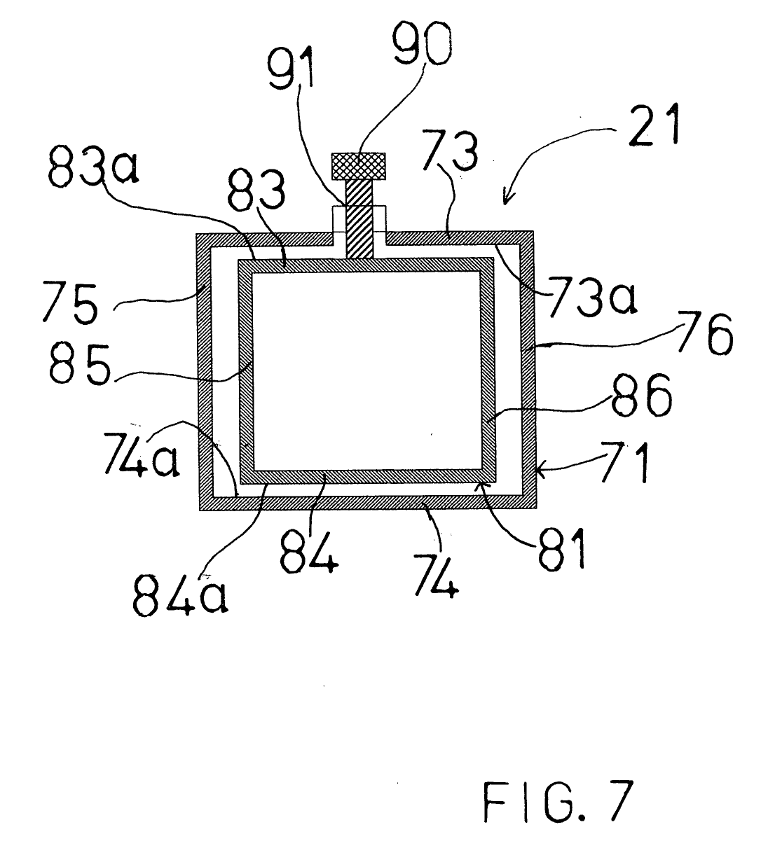

Referring now to the drawings, FIG. 1-7, embodiments of the present invention are described. An adjustable removable golf bag holder 10 is shown generally in the “open” or “down” position in accordance with the invention. Holder 10 includes a lower mounting bracket 31 which attaches to golf cart 11. Lower mounting bracket 31 is secured to golf cart 11 such that non-hinge surface 31a of bracket 31 is in contact with bumper 18 or well bottom 17. Hinge 32 is attached to bracket 31. Left and right lower supports 26, 27, included on holder 10 contain left inside, left outside, right inside and right outside holes 51, 52, 53, 54 for pin 35 allowing connection of holder 10 to hinge 32. Suitable fasteners include, but are not limited to a bolt and nut, or a bar made of metal or other similarly substantial material with holes at either end for cotter pins or similar securing device. Vertical support 25 is secured to left lower support 26 and right lower support 27. Left and right upper supports 23, 24, are secured to vertical support 25. Upper horizontal support 22 is secured to left and right upper supports 23, 24. Left inner, left outer, right inner and right outer golf bag securing strap mounting surface 41, 42, 43, 44 are located on upper horizontal support 22. Left inner, left outer, right inner and right outer golf bag securing strap mounting openings 41a, 42a, 43a, 44a are located through left inner, left outer, right inner and right outer golf bag securing strap mounting surface 41, 42, 43, 44. The present invention is not limited to securing straps. For example, rigid or semi-rigid supports can be provided to secure the golf bag during use.

Adjustable support front mounting device 28 is secured to vertical support 25 in a substantially aligned axis to adjustable support rear mounting device 29 located on upper golf cart horizontal support 63. Adjustable support 21 is connected to horizontal support 25 of holder 10 via adjustable support front mounting device 28 and to golf cart 11 via adjustable support rear mounting device 29.

Adjustable support 21 consists of rear support member 71, forward sliding member 81 and locking mechanism 90. Rear support member 71 consists of a top side member 73, a bottom side member 74, a left side vertical member 75 connecting top side member 73 and bottom side member 74, a right side vertical member 76 parallel to left side vertical member 75 connecting top side member 73 and bottom side member 74. Members 73, 74, 75 and 76 of rear support member 71 form essentially a square configuration. Rear support member 71 is connected to adjustable support rear mounting device 29. Forward sliding member 81 consists of a top side member 83, a bottom side member 84, a left side vertical member 85 connecting topside member 83 and bottom side member 84, a right side vertical member 86 parallel to left side vertical member 85 connecting topside member 83 and bottom side member 84. Members 83, 84, 85 and 86 of forward sliding member 81 form essentially a square configuration. Rear support member 71 is slightly larger than and forward sliding member 81 allowing forward sliding member 81 to be inserted through rear support front opening 77 and into rear support member 71 such that forward sliding member 81 is surrounded by rear support member 71. Rear support member 71 has opening 91 extending from top side surface 73 of top side member 73 through rear support member 71 and extending through interior top side surface 73a of rear support member 71. Locking mechanism 90 is inserted into opening 91. Application of torque to locking mechanism 90 causes the bottom surface 92 of locking mechanism 90 to contact top side surface 83a of top side member 83 of forward sliding member 81. This causes bottom side surface 84a of bottom side member 84 to be forced against interior bottom side surface 74a of bottom side member 74 preventing adjustable support 21 from moving.

The golf bag securing system consists of a left and right adjustable length securing strap 45, 46, and left and right securing strap 47, 48. Left and right securing strap locking mechanism 49, 50 are substantially connected to and left and right securing strap 47, 48. Securing strap locking mechanism is operable to accept the free end of left and right adjustable length securing straps 45, 46.

Holder 10 in use is located in well 13 of a typical golf cart 11. Well 13 is defined by the left and right golf cart fenders 15, 16, wall 14 and well bottom 17 of the golf cart 11 body. Lower mounting bracket 31 is secured to golf cart 11 in well 13 on well bottom 17 or to golf cart bumper 18 by fasteners utilizing left lower fastener opening 33 and right lower fastener opening 34. Fastener holes 19, 19a are made through well bottom 17 or golf cart bumper 18 in positions equivalent to those of left lower fastener opening 33 and right lower fastener opening 34. Fasteners are inserted through left lower fastener opening 33 and right lower fastener opening 34 and through fastener holes 19 or 19a to secure lower mounting bracket 31 to golf cart 11. Holder 10 is attached to lower mounting bracket 31 by inserting pin 35 through left outer hinge opening 36 or right outer hinge opening 37. Pin 35 extends through hinge 32 outer hinge opening 36 or 37 and is held in place by fastener system 38 which may include, but is not limited to a washer and nut. Holder 10 is attached to golf cart 11 via adjustable support 21 and upper horizontal support 63. Adjustable support 21 is secured to golf cart 11 at upper horizontal support 63. Upper horizontal support 63 is attached to golf cart 11 by a fastener through left and right upper horizontal support fastener opening 64, 65 located on horizontal support 63 and left and right golf bag holder support structure openings 68, 69, and connected to original left and right golf cart bag holder support structure 61, 62. By way of background, left and right golf cart bag holder support structure 61 and 62 are original structures contained on golf cart 11 and are connected to golf cart deck 66 and golf cart seats 67.

Golf bags are secured to holder 10 by placing the top or open end of a golf bag against upper horizontal support 22 and the bottom or closed end of a golf bag into well 17. Left or right adjustable securing strap 45, 46 is wrapped around golf bag and the free end of the left or right adjustable securing strap 45, 46 is placed through the left or right securing strap locking mechanism 49, 50 which are affixed at approximately the ends of left or right securing strap 47, 48. Upon closing of left or right securing strap locking mechanism 49, 50, left or right adjustable securing strap 45, 46 is held in place preventing golf bag from falling out of or moving around while golf cart 11 is in motion.

The above description and drawings are only to be considered illustrative of exemplary embodiments that achieve the features and advantages of the invention. Although exemplary embodiments of the present invention have been described and illustrated herein, many modifications, even substitutions of materials, can be made without departing from the spirit or scope of the invention. Accordingly, the above description and accompanying drawings are only illustrative of exemplary embodiments that can achieve the features and advantages of the present invention. It is not intended that the invention be limited to the embodiments shown and described in detail herein. The invention is limited only by the scope of the appended claims.

What is claimed is:

1. An adjustable golf bag holder for use on a golf cart comprising:
a frame;
a mounting bracket for securing to available present structural elements of the golf cart, the mounting bracket is coupled to the frame to allow pivoting of the frame relative to the mounting bracket;
a golf bag securing device to removably secure one or more golf bags to the frame during use, such that an open end of the golf bag is supported by the golf bag securing device and the closed end of the golf bag rests in the golf cart; and
an adjustable support coupled to the frame to adjust a vertical angle of the frame such that the one or more golf bags secured to the frame have a substantially non-perpendicular angle relative to the golf cart such that the open end of the one or more golf bags laterally extend from a back of the golf cart.

2. The adjustable golf bag holder of claim 1 wherein the adjustable support is continuous and allows for adjustment to any angle preferred by the golfer within the effective range of the holder wherein the adjustable support has an operable range of motion from 0 to 35 degrees where the user can select an angle preferred by the user.

3. The adjustable golf bag holder of claim 1 wherein the adjustable support contains defined stops allowing for limited positioning of the holder angle available to the user where a series of predefined stops between the effective range of the adjustable support wherein the user can select an from a predetermined angle of 10, 15, 20, 25, 30 or 35 degrees by moving a pin or lock key and inserting same through a corresponding opening extending through the forward sliding member and rear support member.

4. The adjustable golf bag holder of claim 1 wherein the adjustable support is a pneumatic or hydraulic pressure device which maintains the desired angle.

5. The adjustable golf bag holder of claim 1 wherein the adjustable support utilizes a pressure locking device to maintain the desired angle.

6. The adjustable golf bag holder of claim 1 wherein the adjustable support is a predetermined length.

7. The adjustable golf bag holder of claim 1 wherein the golf bag securing device is the factory installed securing device of the golf cart mounted to the frame.

8. An adjustable golf bag holder for use on a golf cart comprising:
a means for attaching a mounting bracket to available present structural elements of a golf cart;
a means for attaching an adjustable golf bag holder to a mounting bracket allowing for the holder to be pivoted to a vertical angle relative to the golf cart preferred by the user; and
a means for securing the golf bag holder to a vertical angle relative to the golf cart such that the angle is not modified due to external forces applied to the golf bag holder due to movement of the golf cart.

9. The adjustable golf bag holder of claim 8 wherein the means for adjusting the vertical angle of the holder is an adjustable support which allows for adjustment of the holder to any angle preferred by the user within the operable effective range of motion of the adjustable support wherein the adjustable support has an operable effective range of motion form 0 to 35 degrees.

10. The adjustable golf bag holder of claim 8 wherein the means for adjusting the vertical angle of the holder is an adjustable support which contains defined stops within the operable effective operable range of the adjustable support wherein the adjustable support has an operable effective range of motion form 0 to 35 degrees and contains defined stop points at 0, 15, 20, 25, 20 and 35 degrees.

11. A method of securing a golf bag to a golf cart comprising:
placing the closed end of a golf bag within a golf cart and resting the open end of the golf bag against an adjustable frame; and
securing the golf bag to the adjustable frame by maneuvering the free end of a securing strap around the top of the golf bag, placing the free end of the securing strap into and through a locking mechanism and activating the locking mechanism preventing the securing strap from becoming loose due to external forces being applied to the securing strap and locking mechanism due to movement of the golf cart.

12. The method of claim 11 wherein the locking mechanism allows for continuous adjustment of the securing strap.

13. The method of claim 11 wherein the securing strap contains defined stop points allowing limited positioning of the securing strap within the locking mechanism thereby allowing for limited adjustment of the securing strap.
